(19) United States
(12) Patent Application Publication
(10) Pub. No.: US 2007/0046644 A1
(43) Pub. Date: Mar. 1, 2007

(54) ELECTRONIC APPARATUS HAVING BUTTONS WITHOUT FORMING GAPS THEREIN

(75) Inventors: San-Feng Lin, Taipei (TW); Hui-Wen Chiu, Taipei (TW); Yen-Yu Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 11/461,781

(22) Filed: Aug. 2, 2006

(30) Foreign Application Priority Data
Aug. 23, 2005 (TW) 94128703

(51) Int. Cl. G09G 5/00

(52) U.S. Cl. 345/173

(57) ABSTRACT

An electronic apparatus having buttons without forming gaps therein comprises a housing having a first opening, an operation element, a supporting plate, a touch circuit board and at least one switch component. The operation element comprises a touch pad, a first fixing part and a button part. The touch pad and the button part form a flat surface. The operation element disposed in the first opening of the housing is fixed to the lower surface of the housing through the use of the first fixing part. In addition, the supporting plate used to support the button part is arranged underneath. The touch pad is covered by the touch circuit board so as to provide the control function and at least one switch component is arranged under the button part to enable the switch component being actuated when the button part is pressed downward.

### CROSS-REFERENCE TO RELATED APPLICATION

This application claims the priority benefit of Taiwan application serial no. 94128703, filed on Aug. 23, 2005. All disclosure of the Taiwan application is incorporated herein by reference.

### BACKGROUND OF THE INVENTION

1. Field of Invention

The present invention relates to an electronic apparatus. More particularly, the present invention relates to an electronic apparatus having buttons without forming gaps.

2. Description of Related Art

In the world of information explosion, the using of notebook computers has become a noticeable trend as the notebook computer users are amazed by the portability and convenience. The emergence of notebook computers has set a milestone for the information industry which has rapidly progressed in recent years.

Since a notebook computer integrates the display, host and input devices as a whole, there are many more considerations that are different from the design of a desktop computer. As for the function of controlling the cursor location on the screen, in order to be carried conveniently, a notebook computer does not use the conventional mouse design; instead, the touch pad and control buttons integrated on the housing of the notebook computer are employed to achieve the function a mouse serves. Nowadays, the touch pad and control buttons have also become the most common means to replace the mouse for a notebook computer.

FIG. 1 is a schematic diagram of a conventional module with a touch pad and buttons. With reference to FIG. 1, a touch pad 120 is disposed on the housing 100 of the conventional notebook computer and the touch pad 120 is electrically connected to a touch pad circuit which is under the touch pad 120 as the input device for controlling the cursor on the screen. The module further includes a plurality of buttons 130 which are at the lower portion of the touch pad 120, so that the switch components underneath can be touched when a user presses one of the buttons to input commands. In other words, the touch pad 120 and the buttons 130 are separately different components, and the material of the buttons 130 may be plastic or alloy, etc. Therefore, no matter how precise the assembly is, the gaps 140 between the touch pad 120 and the button part 130 can be obviously seen. Despite of the shapes of the touch pads and buttons designed by different manufacturers, such design is the most common touch pad and button module on the current market. However, there are some shortcomings existed in such design:

1. Nowadays, in the trend that requires that the appearance of a product be attracted to consumers, the appearance design of the conventional touch pad and buttons is too complicated, and lack of simplicity.

2. The touch pad and buttons are separately different parts, which means the touch pad and the buttons have to be made by different molds and assembled separately. The manufacturing cost incurred thereof is not economically profitable, especially at present when the profit margin of notebook computers is getting narrower and narrower.

3. Because the gaps between the touch pad and buttons exists, foreign objects may easily enter inside of the notebook computer through the gaps. After a long time period of use, the accumulation of too many foreign objects inside the notebook computer may result in failure of the internal functions of the notebook computer. In addition, if a user accidentally spills liquid over the computer, such as drinks, the existence of the gaps will make the liquid easily flow into the notebook computer and causes severe damages on its internal electronic components.

### SUMMARY OF THE INVENTION

The object of the present invention is to provide an electronic apparatus having buttons without forming gaps, so as to reduce the manufacturing cost, prevent foreign objects from entering into the notebook computer and have a simple and elegant appearance.

The present invention provides an electronic apparatus having buttons without forming gaps therein, comprising a housing, a touch circuit board, at least one switch component and an operation element. The housing has a first surface, a second surface opposite to the first surface and a first opening passing through the first surface and the second surface. The operation element comprises a touch pad, a first fixing part and a button part. The touch pad is located on a first portion of the first opening, and is covered by the touch circuit board. The first fixing part is connected to at least one first side of the touch pad to fix the touch pad on the second surface. The button part is located on a second portion of the first opening, and the button part is connected to a second side of the touch pad. And the button part faces the switch components. By pressing the button part can move at least one part of the button part for a first distance, so that the switch component is actuated by the button part.

According to one embodiment of the present invention, the first portion of the first opening and the second portion of the first opening partially cover the first opening. Moreover, the electronic apparatus having buttons without forming gaps may further includes a decoration frame disposed on the first opening, and the decoration frame has a second opening to install the operation element. In addition, the operation element is exposed from the second opening.

According to one embodiment of the present invention, a plurality of hot melt bosses are disposed on the second surface. The first fixing part has a plurality of through holes corresponding to the hot melt bosses, so that the operation element can be fixed on the housing through heat sealing.

According to one embodiment of the present invention, the electronic apparatus further includes a narrow gap on the button part, and the narrow gap is adjacent to the second side. In addition, the narrow gap provides a first elastic arm for the button part.

According to one embodiment of the present invention, wherein the button part further includes at least one second elastic arm disposed on at least one third side of the button part, and the second elastic arm is connected to the second surface.

According to one embodiment of the present invention, wherein there is a first distance between the button part and the switch component, and the button part further includes at least one rib corresponding to the switch component.

According to one embodiment of the present invention, the electronic apparatus further includes a supporting plate. At least one portion of the supporting plate sustains a back of the button part, and at least one portion of the supporting plate is fixed on the second surface.

According to one embodiment of the present invention, the touch pad and the button part exposed from the first opening form a flat surface.

Since the present invention utilizes the electronic apparatus having buttons without forming gaps, therefore a simple and elegant appearance of product can be provided. In addition, since there is no gap between the touch pad and the button part in the electronic apparatus, foreign objects can therefore be prevented from entering into the product. Moreover, since the electronic apparatus having buttons without forming gaps according to the embodiment of the present invention has an integrated touch pad and button part, therefore less molds need to be created, and the manufacturing cost can be reduced accordingly.

### BRIEF DESCRIPTION OF THE DRAWINGS

FIG. 1 is a schematic diagram of a conventional touch pad and button module.

FIG. 2A is a schematic front-side view of the housing according to an embodiment of the present invention.

FIG. 2B is a schematic rear-side view of the housing according to an embodiment of the present invention.

FIG. 3 is a schematic front-side view of the operation element according to an embodiment of the present invention.

FIG. 4 is a schematic rear-side view of the operation element assembled on the housing according to the first embodiment of the present invention.

FIG. 5 is a schematic enlarged view of the area A in FIG. 3.

FIG. 6 is a schematic assembling diagram of the component combination and a supporting plate in FIG. 4.

FIG. 7 is a schematic assembling diagram of the component combination of FIG. 6 and a circuit board with switch components.

FIG. 8 is a schematic diagram of the relative position of the ribs and the switch components.

FIG. 9 is a schematic front-side view of the assembled electronic apparatus having buttons without forming gaps according to the embodiment of the present invention.

FIG. 10 is a schematic front-side view of the assembled electronic apparatus having buttons without forming gaps according to the second embodiment of the present invention.

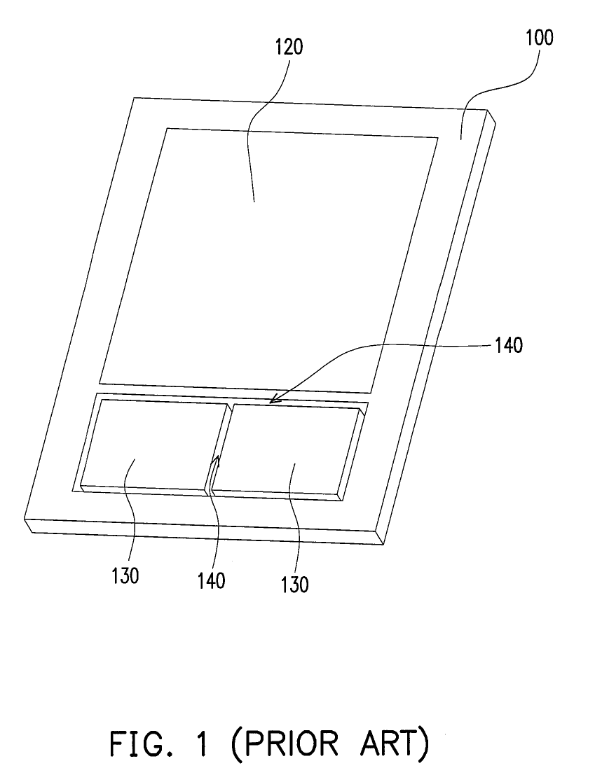

### DESCRIPTION OF EMBODIMENTS

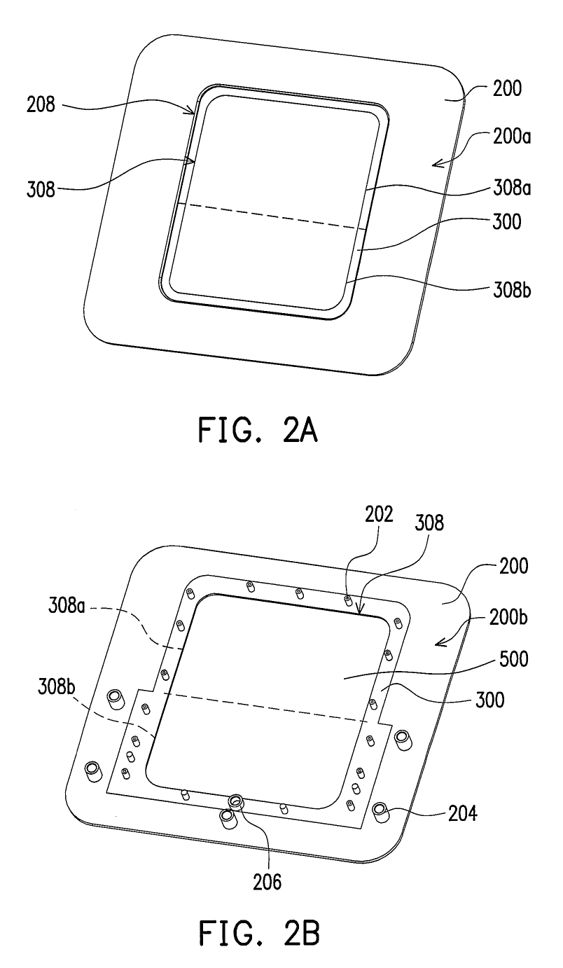

FIG. 2A is a schematic front-side view of the housing according to the first embodiment of the present invention. FIG. 2B is a schematic rear-side view of the housing of the first embodiment according to the present invention. With reference to FIG. 2A and FIG. 2B, the housing 200 has a first surface 200a and a second surface 200b corresponding thereto, a plurality of hot melt bosses 202 disposed on the second surface 200b, a plurality of first protrusions 204 and a second protrusion 206. The center of the housing 200 further has a first opening 208 passing through the first surface 200a and the second surface 200b.

As described above, the housing 200 in the present embodiment is connected to the decoration frame 300 which is disposed on the first opening of the housing 200 from the back of the housing 200. The center of the decoration frame 300 has a second opening 308. The second opening 308 can be further divided into a first portion 308a and a second portion 308b. The decoration frame 300 further includes holes corresponding to the hot melt bosses 202 which are disposed on the back side of the decoration frame 300, so that the decoration frame 300 can be assembled with the back of the housing 200. In this embodiment, the material of the decoration frame 300 may be plastic, rubber or alloy and etc. The advantage for adding the decoration frame 300 is to increase the variety of appearance and color to the electronic apparatus.

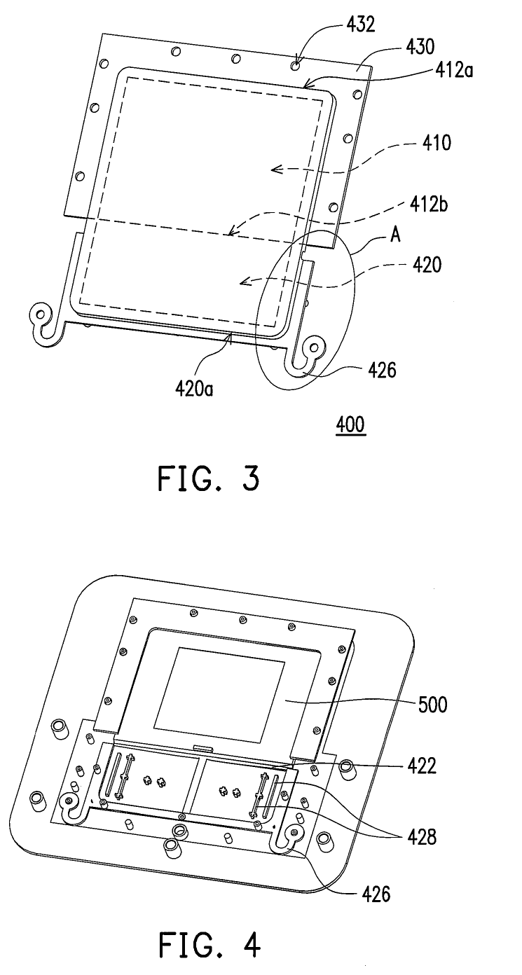

FIG. 3 is a schematic front-side view of the operation element of the first embodiment according to the present invention. FIG. 4 is a schematic rear-side view of the operation element assembled on the housing according to the first embodiment of the present invention. With reference to FIG. 2B, FIG. 3 and FIG. 4, the operation element 400 includes a touch pad 410, a button part 420 and a first fixing part 430. The touch pad 410 and the button part 420 are on the adjacent surface and disposed in the second opening 308 of the decoration frame 300 for user's operation, wherein the touch pad 410 is located at the first portion 308a of the second opening 308. As shown in FIG. 4, the touch pad 410 is covered by a touch circuit board 500 to provide touching control function. The first fixing part 430 is adjacent to at least the first side 412a of the touch pad 410. The first side 412a has a plurality of through holes 432 corresponding to the hot melt bosses 202 on the housing 200 so that the through holes 432 can be inserted by the hot melt bosses 202. Therefore, the operation element 400 can be fixed on the housing 200 using heat sealing through the hot melt bosses 202. It should be noted that the fixing means for the operation element 400 is not limited to the heat sealing described above; other methods such as rivet jointing method can also be used.

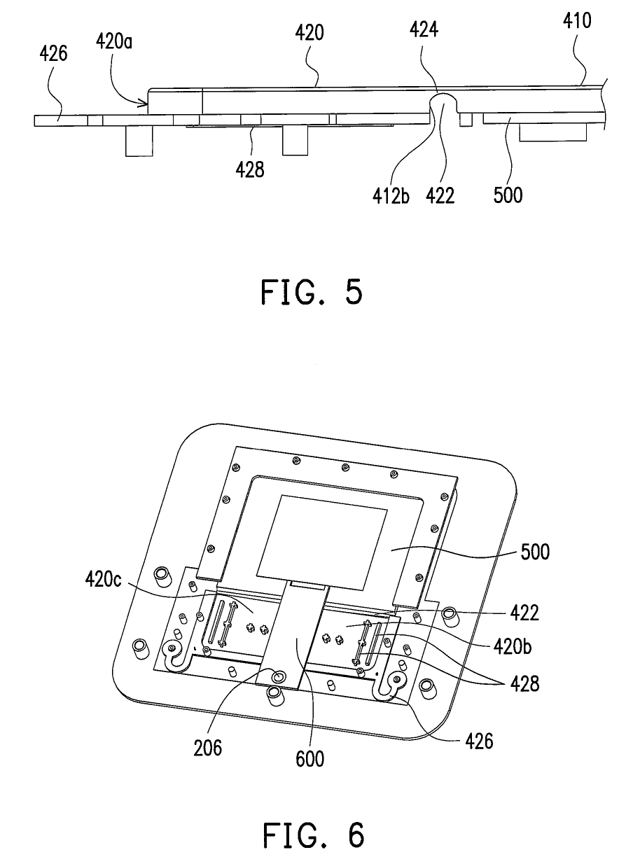

As described above, the button part 420 is adjacent to the second side 412b, and is located at the second portion 308b of the second opening 308. FIG. 5 is a schematic detailed view of the area A in FIG. 3. With reference to FIG. 3, FIG. 4 and FIG. 5, the button part 420 includes a narrow gap 422 adjacent to the touch pad 410, a first elastic arm 424 and the second elastic arm 426 located at the third side 420a of the button part 420. In addition, the button part 420 further includes a plurality of ribs 428.

The narrow gap 422 is used to separate the touch pad 410 and the button part 420. The first elastic arm 424 and the second elastic arm 426 can serve as the elastic supporting arms when the button part 420 is pressed by a user's external force. When the external force is removed, the button part 420 can be resumed to the original position through the first elastic arm 424 and the second elastic arm 426. The second elastic arm 426 is connected to the second surface 200b of the housing 200, wherein the connecting method thereof, for example, is to inset the through holes on the second elastic arm 426 to the hot melt bosses 202 of the housing 200, and then fix its position by using heat sealing.

FIG. 6 is a schematic assembling diagram of adding a supporting plate in FIG. 4. With reference to FIG. 2B, FIG. 3 and FIG. 6, the button part 420 includes a left button part 420b and a right button part 420c. When the user presses downward either the left button part 420b or the right button part 420c, a supporting plate 600 is provided to the back of the button part 420, to avoid the linking-up due to the integration of the left button part 420b and the right button part 420c. At least one portion of the supporting plate 600 needs to be located in the back of the button part 420 to support the button part 420. Other portions of the supporting plate 600 may be fixed on the second surface 200b of the housing 200. In FIG. 6, the supporting plate 600, for example, has a through hole so that the second protrusion 206 on the second surface 200b can be inset into the through hole of the supporting plate 600 and be fixed. The design of the supporting plate 600 is used only for describing the present embodiment and should not be limited to the present invention. Of course, the supporting plate 600 design can be omitted if the button part 420 is designed with only a single button function.

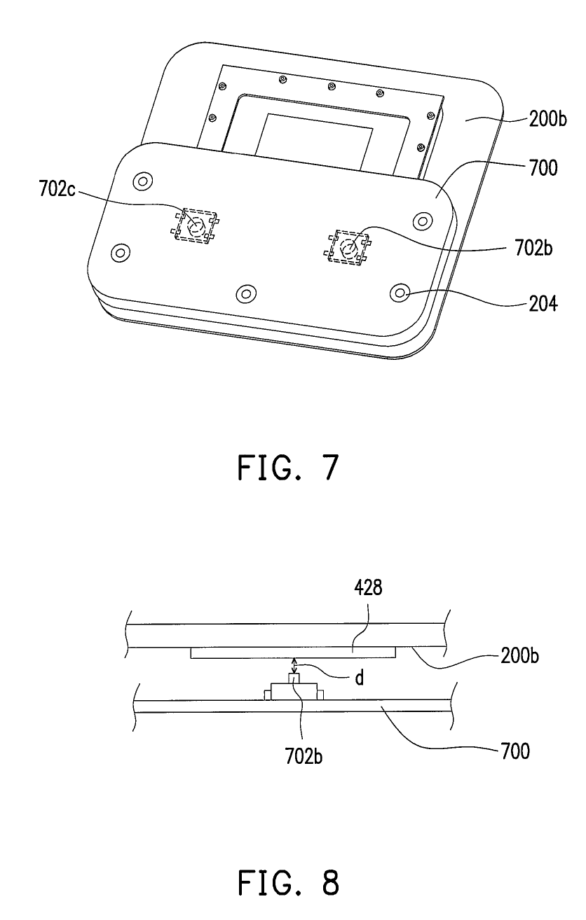

FIG. 7 is a schematic assembling diagram of the component combination of FIG. 6 and a circuit board with switch component. With reference to FIG. 3, FIG. 4 and FIG. 7, in the present embodiment, since the button part 420 is capable of dual buttons function, there are two switch components 702b and 702c on the circuit board 700, and the positions thereof correspond to a plurality of ribs 428 on the button part 420. FIG. 8 is a schematic diagram of the relative position of the ribs and the switch components. With reference to FIG. 2B, FIG. 6, FIG. 7 and FIG. 8, the switch components 702b and 702c respectively have a first distance d between the ribs 428. When either the left button part 420b or the right button part 420c is pressed, the ribs 428 move downward at a first distance d to actuate the corresponding switch components 702b or 702c. In addition, the assembling of the circuit board 700 utilizes the through holes corresponding to the first protrusion 204 on the second surface 200b to inset the first protrusion 204 into the through holes and fix them.

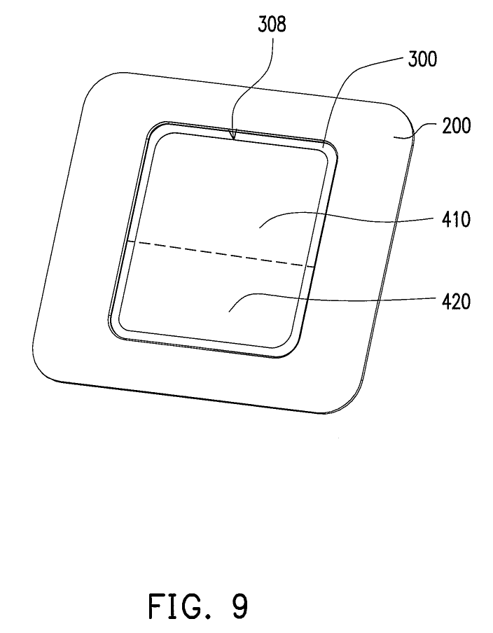

FIG. 9 is a schematic front-side view of the assembled electronic apparatus having buttons without forming gaps according to the first embodiment of the present invention. With reference to FIG. 9, wherein the touch pad portion 410 and the button part 420 form a flat surface in the second opening 308 of the decoration frame 300, thereby achieving the electronic apparatus having buttons without forming gaps and the electronic apparatus can be capable of touch control function and button function.

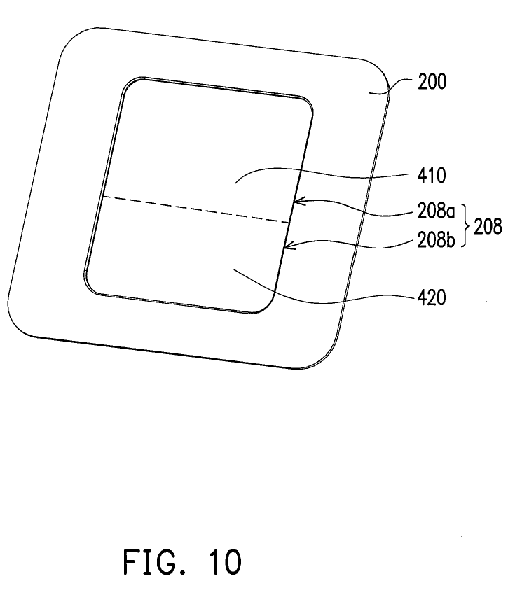

FIG. 10 is a schematic front-side view of the assembled electronic apparatus having buttons without forming gaps according to the second embodiment of the present invention. With reference to FIG. 10, the structure of the second embodiment is similar to the first embodiment, while the only difference is that there is no decoration frame 300 in the second embodiment. Therefore, the touch pad portion 410 and the button part 420 are disposed directly in the first opening 208 of the housing 200 for the user's operation. The first opening 208 can be further divided into the first portion 208a and the second portion 208b. The touch pad portion 410 is located at the first portion 208a of the first opening 208, while the button part 420 is located at the second portion 208b of the first opening 208. Such design can also reach the same goal of the first embodiment.

As described above, a flat surface can be formed by the touch pad portion and the button part according to the preferred embodiment of the present invention, so that a simple and elegant appearance of the product can be implemented; meanwhile, the touch control and button function can also be provided. In addition, since the electronic apparatus has buttons without forming gaps according to the preferred embodiment of the present invention, therefore the foreign objects can be prevented from entering into the product. Moreover, since the touch pad portion and button part of the preferred embodiment of the present invention are integrated together as a whole, therefore less molds need to be created and thus the manufacturing cost can be reduced accordingly.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic apparatus having buttons without forming gaps, comprising:
a housing, having a first surface, a second surface opposite to the first surface and a first opening passing through the first surface and the second surface;
a touch circuit board;
at least one switch component; and
an operation element, comprising:
a touch pad, located at a first portion of the first opening and covered by the touch circuit board;
a first fixing part, adjacent to at least one first side of the touch pad to fix the touch pad on the second surface; and
a button part, located at a second portion of the first opening and being adjacent to a second side of the touch pad, wherein the button part faces to the switch component; when the button part is pressed, at least one part of the button part is moved for a first distance, and the button part actuates the switch component.

2. The electronic apparatus as claimed in claim 1, wherein the button part includes a narrow gap being adjacent to the second side.

3. The electronic apparatus as claimed in claim 2, wherein the narrow gap corresponding to the touch pad and the button part forms a first elastic arm of the button part.

4. The electronic apparatus as claimed in claim 1, wherein the first portion of the first opening and the second portion of the first opening partially cover the first opening.

5. The electronic apparatus as claimed in claim 1, wherein the button part further comprises at least one rib corresponding to the switch component.

6. The electronic apparatus as claimed in claim 1, wherein the button part further comprises at least one second elastic arm connecting to the second surface.

7. The electronic apparatus as claimed in claim 1, further comprising a decoration frame disposed on the first opening, and the decoration frame having a second opening for installing the operation element, and the operation element being exposed from the second opening.

8. The electronic apparatus as claimed in claim 1, wherein a plurality of hot melt bosses are disposed on the second surface, and the first fixing part having a plurality of through holes corresponding to the hot melt bosses, so as to fix the operation element on the housing by heat sealing.

9. The electronic apparatus as claimed in claim 1, wherein there is a first distance between the button part and the switch component.

10. The electronic apparatus as claimed in claim 1, further comprising a supporting plate, at least one portion of the supporting plate supporting on a back of the button part, and at least one portion of the supporting plate being fixed on the second surface.

11. The electronic apparatus as claimed in claim 1, wherein the touch pad and the button part exposed from the first opening form a flat surface.
